(19) United States
(12) Patent Application Publication
(10) Pub. No.: US 2023/0036408 A1
(43) Pub. Date: Feb. 2, 2023

(54) SYNERGISTIC FLAME & SMOKE SUPPRESSING COMPOSITION FOR PLASTIC APPLICATIONS

(71) Applicant: Lubrizol Advanced Materials, Inc., Cleveland, OH (US)

(72) Inventors: Brian Guhde, Rocky River, OH (US); Li Nie, Broadview Heights, OH (US); Mark Knurek, Broadview Heights, OH (US); Christopher D. Zook, Akron, OH (US)

(73) Assignee: Lubrizol Advanced Materials, Inc., Cleveland, OH (US)

(21) Appl. No.: 17/786,806

(22) PCT Filed: Dec. 15, 2020
(86) PCT No.: PCT/US2020/065026

§ 371 Date: Jun. 17, 2022

Related U.S. Application Data
(60) Provisional application No. 62/956,702, filed on Jan. 3, 2020.

(51) Int. Cl. C08F 114/06; C08K 3/24; C08K 3/22

(52) U.S. Cl. CPC C08F 114/06; C08K 3/24; C08K 3/22; C08K 2003/2224; C08K 2201/005

(57) ABSTRACT

This invention relates to a synergistic combination of molybdate salts (e.g., calcium molybdate) and magnesium hydroxide to suppress both smoke and flame in polymeric compositions, such as plastic piping, profile applications, wire and cable, semiconductor and electrical conduit application, to name a few. In some embodiments, the technology relates to polyvinyl chloride (“PVC”) and chlorinated polyvinyl chloride (“CPVC”) compounds, among other polymer resin containing compounds, having improved smoke and flame performance from the synergistic combination of molybdate salts and magnesium hydroxide.

### FIELD OF THE INVENTION

This invention relates to a synergistic combination of molybdate salts (e.g., calcium molybdate) and magnesium hydroxide to suppress both smoke and flame in halogenated polymeric compositions, such as plastic piping, profile applications, wire and cable, semiconductor and electrical conduit applications, to name a few. In some embodiments, the technology relates to polyvinyl chloride (“PVC”) and chlorinated polyvinyl chloride (“CPVC”) compounds having improved smoke and flame performance from the synergistic combination of molybdate salts and magnesium hydroxide.

### BACKGROUND OF THE INVENTION

CPVC pipe has enjoyed great commercial success mainly because of its excellent physical and chemical properties. CPVC pipes are also simple to install in a plumbing system. The CPVC pipes also have excellent corrosion resistance, which allows their use in many industrial installations to transport corrosive fluids. CPVC pipes have also found a large use in dwellings to replace copper pipes for hot and cold water distribution systems and for fire sprinkler systems.

Among other tests, plastic pipes, conduits, and other profiles used in plenum applications must meet the requirements of the standard test methods for surface burning characteristics of building materials (ASTM E84 and/or UL 852). PVC and CPVC plastic products available commercially today have difficulty meeting the UL 852 and E84 requirements without extra protective steps, such as surface coating or wrapping with other protective films or sheets or woven/non-woven materials. These extra protective steps can add significant cost. Thus, there is a need to make plastic pipes or other profile that can pass plenum requirements, and at realistic costs and ease of installation.

It would be very desirable to have a halogenated polymer resin pipe that is able to pass the UL 852 and E84 test without additional protective measures.

### SUMMARY OF THE INVENTION

The disclosed technology provides a compound that includes a halogenated polymer resin, such as PVC or CPVC, as well as a synergistic combination of a molybdate and magnesium hydroxide. In embodiments, the composition can also optionally include an acrylate impact modifier.

The compound has multiple uses. In an embodiment, the compound can be employed to prepare a pipe. The compound can also be employed to prepare a pipe fitting, as well as a solvent cement. The flame and smoke composition can also be employed in a solvent cement along with the halogenated polymer resin. One aspect of the technology therefore includes a pipe, a pipe fitting, and a solvent cement. Another aspect of the technology includes a system of the pipe and pipe fitting welded together with the solvent cement.

A system prepared from pipes, fittings and solvent cement all made with the flame and smoke composition will exhibit improved flame and smoke reduction.

The technology also provides a method to pass the ASTM E84 for surface burning by employing the discussed compound. Also provided is a method to pass the ASTM E84 for smoke spread by employing the discussed compound.

The disclosed technology further provides a pipe prepared from a CPVC composition as set forth above, as well as a method of providing enhanced smoke reduction in CPVC pipe by extruding a pipe from a compound as set forth above.

In the course of discovering this novel and synergistic combination, it has been discovered that the composition can also be employed in other plastic applications, such as, semiconductor applications; wire and cable applications; and electrical conduit. Thus, the technology also provide compositions and methods for improving smoke and flame performance in plastic applications in general, with a composition containing a halogenated polymer resin, the synergistic combination of a molybdate and magnesium hydroxide, and other additives suitable for use in the particular plastic application.

### DETAILED DESCRIPTION OF PREFERRED EMBODIMENTS

Exemplary embodiments in accordance with the present invention will be described. Various modifications, adaptations or variations of the exemplary embodiments described herein may become apparent to those skilled in the art as such are disclosed. It will be understood that all such modifications, adaptations or variations that rely upon the teachings of the present invention, and through which these teachings have advanced the art, are considered to be within the scope and spirit of the present invention.

The methods, halogenated polymers and compositions of the present invention may suitably comprise, consist of, or consist essentially of the components, elements, steps, and process delineations described herein. The invention illustratively disclosed herein suitably may be practiced in the absence of any element which is not specifically disclosed herein.

Unless otherwise stated, all part levels of the ingredients of the flame and smoke composition are based on 100 parts by weight of halogenated polymer resin, abbreviated as “phr.”

Here, as well as elsewhere in the specification and claims, individual numerical values or range limits of ingredients, can be combined to form additional non-disclosed and/or non-stated ranges or levels of ingredients of the CPVC composition.

The technology encompasses a composition having (a) a halogenated polymer resin, (b) at least one molybdate salt, and (c) magnesium hydroxide.

### Halogenated Polymer Resin

A halogenated polymer resin will be present in the flame and smoke composition at 100 parts by weight, and the concentration of all other ingredients in the flame and smoke composition are based on levels per 100 parts by weight of the halogenated polymer resin.

The halogenated polymer resin employed in the composition is not particularly limited. Halogenated Polymer resins can include polymers used in many different applications, for example, those used in residential and commercial plumbing, such as potable water or drain, waste and vent applications; residential and commercial fire sprinkler systems; residential and commercial profile applications, such as, siding, window framing, cabinet finishes, flooring, aircraft interior, roofing tiles, cap stock and the like; industrial piping, such as chemical processing or wastewater treatment; semiconductor applications; wire and cable applications; electrical conduit; masterbatch applications, and so on, as well as the associated fittings and molded components for each application. Halogenated polymers can include, but are not limited to, for example, polymers of vinyl chloride, including homopolymers of polyvinyl chloride (“PVC”) or chlorinated polyvinyl chloride (“CPVC”); copolymers of vinyl chloride with ethylene-type unsaturated compounds, such as PVC-VA (vinyl acetate) copolymers, PVC-acrylate and the like.

In an embodiment, the polymer resin can be chlorinated polyvinyl chloride (“CPVC”). CPVC may be derived from a PVC copolymer having about 5 parts or less of a co-monomer. Where the precursor PVC contains less than about 5 parts total of one or more co-monomers per 100 parts of vinyl chloride, the chlorinated version of this polymer will also be referred to herein as CPVC.

Co-monomers in the CPVC resin can include esters of acrylic acid wherein the ester portion has from 1 to 12 carbon atoms, for example, methyl acrylate, ethyl acrylate, butyl acrylate, octyl acrylate, cyano-ethyl acrylate, and the like; vinyl acetate; esters of methacrylic acid wherein the ester portion has from 1 to 12 carbon atoms, such as methyl methacrylate (MMA), ethyl methacrylate, butyl methacrylate, and the like; acrylonitrile, and methacrylonitrile; styrene derivatives having a total of from 8 to 15 carbon atoms such as alpha-methylstyrene, vinyl toluene, chlorostyrene; vinyl naphthalene; diolefins having a total of from 4 to 8 carbon atoms such as isoprene, and including halogenated olefins such as chlorobutadiene, monoolefins such as ethylene and propylene and having from 2 to 10 carbon atoms, desirably 2 to 4 carbon atoms and preferably 4 carbon atoms, with isobutylene being highly preferred. If co-monomers are used, preferred are MMA, co-polymerizable imides such as N-cyclohexyl maleimide and co-monomers known to co-polymerize with vinyl chloride monomer and yield a copolymer having a Tg equal to or higher than homo-PVC. The preferred CPVC is derived from a PVC homopolymer. It is also contemplated that a small portion of the solvent in which the PVC is polymerized can copolymerize therewith. For example, vinyl chloride can advantageously be prepared in the presence of a chain modifying co-reactant solvents such as, for example, THF, an ethylenically unsaturated alkylene such as an alpha olefin or a reactive mercaptan such as 2-mercapto ethanol, and small portions thereof may be present as co-monomer in the resultant PVC.

CPVC resin is known to the art and to the literature and is commercially available. In theory, CPVC employed herein may contain generally small amounts of non-chlorinated repeat units of vinyl chloride (VC) monomer. The amount of residual VC monomer repeat units can be from about 45.0 to about 62.0 wt %

The CPVC resin is made from a PVC resin having an intrinsic viscosity (I.V.), measured as stated in ASTM D1243 of from 0.5 to 1.25, or from 0.68 to 0.92, or from 0.80 to 1.05, or even from 0.86 to 0.96, or 0.68 to 0.92. The preferred CPVC composition has at least 50, or even at least 60 or 70 wt. %, or 85 wt. % of the composition as CPVC resin. The wt. % chlorine in the CPVC resin will affect the HDT (heat distortion temperature), as measured according to ASTM D648, of the CPVC composition. In general, with all other ingredients of the CPVC composition being constant, the HDT will be higher when the chlorine content of the CPVC resin is higher. In some embodiments, the chlorine content of the CPVC resin can be from about 63 to about 70 wt. %, or in other embodiments, from about 64 to 69 wt. %, or even from about 65 to about 68 wt. %.

In another embodiment, the polymer resin can be polyvinyl chloride (“PVC”).

In embodiment, the polymer resin can be a mixture of halogenated polymer resins, such as, for example, a mixture of PVC and CPVC.

### Synergistic Flame and Smoke Package

The flame and smoke composition will include a synergistic combination of a molybdate salt and magnesium hydroxide.

Example molybdenum salts can be in the form of alkali metal molybdates, alkaline earth metal molybdates, such as calcium molybdate, magnesium molybdate and the like, or ammonium molybdates, such as ammonium octamolybdate. Some specific examples of suitable molybdate salts include CaMoO₄, ammonium 5-molybdocobaltate (III), ammonium dimolybdate, ammonium molybdate, ammonium heptamolybdate, ammonium octamolybdate. It has been found that calcium molybdate provides a unique performance with respect to the E84 UL 852 tests, and in one embodiment the molybdate salt includes calcium molybdate. It has also been found that ammonium octamolybdate provides a unique performance with respect to the E84 UL 852 tests, and in one embodiment the molybdate salt includes ammonium octamolybdate.

In some embodiments, the molybdate salt can be milled to reduce the particle size. For example, the molybdate may be milled to a D50 volume distribution particle size of less than 1 μm or lower, or even 0.75 μm or lower, or 0.5 μm or lower measured by laser diffraction.

The flame and smoke composition will have about 0.5 to about 20 phr of molybdate salt, or from about 0.75 to about 12.5 or 15 phr. In some embodiments, the level of the molybdate salt can be from about 1 to about 10 phr, or about 1.25 or 1.5 to about 8 phr, or from about 2 to about 6 phr.

Magnesium hydroxide will also be in the flame and smoke composition. The composition could have greater than about 0.5 phr of magnesium hydroxide, or in some embodiments, from about 0.5 to about 25 or 30 phr of magnesium hydroxide. In some embodiments, the composition can contain from about 0.75 to about 17.5 or 20 phr, or from about 1 to 15 phr magnesium hydroxide, or in some embodiments, from about 1.25 to about 12.5 phr of a magnesium hydroxide. In some embodiments, the level of the magnesium hydroxide can be from about 1.5 to about 10 phr, or from about 2 to about 10 phr or about 5 to 15 phr. A load level of from about 9 to about 12 phr may also be a suitable level of the magnesium hydroxide in the CPVC composition.

In some embodiments, the ratio of the molybdate salt to the magnesium hydroxide can be from about 5:1 to 1:5, or even 3:1 to 1:3. In some instances, the ratio of the molybdate salt to the magnesium hydroxide can be about 1:3 or greater (i.e., greater amount of magnesium hydroxide than molybdate salt), or 1:2 or greater, or even 3:4 or greater, or from about 1:1 to about 1:5, or about 1:1 to 1:3, or even about 3:4 to 1:2.

### Other Additives

The flame and smoke composition can also contain other additives useful in the intended application for the compositions. For example, some compositions, such as those with CPVC, PVC and ABS resins for example, can include an impact modifier. Suitable impact modifiers include acrylic, acrylonitrile butadiene styrene (“ABS”) and methacrylate butadiene styrene (“MBS”) graft copolymers.

Acrylic impact modifiers can be considered “core-shell” compositions. U.S. Pat. No. 3,678,133 describes acrylic impact modifiers as composite interpolymers comprising a multi-phase acrylic base material comprising a first elastomeric phase polymerized from a monomer mix comprising at least 50 wt. % alkyl methacrylate having 1-4 carbon atoms in the alkyl group and having a molecular weight of from 50,000 to 600,000. Further, the patent states that the polymerization of the rigid thermoplastic phase is preferably conducted in such a fashion that substantially all of the rigid phase material is formed on or near the surface of the elastomeric phase. Both the surface, or shell, phase and the core phase can be prepared from either a homo- or a co-polymer of polyacrylates including (C₄-C₁₂) acrylate homo or copolymers, second stage graft copolymerized with methyl methacrylate and styrene, poly(ethylhexyl acrylate-co-butyl-acrylate) graft copolymerized with styrene, and/or acrylonitrile and/or methyl methacrylate; polybutyl acrylate graft polymerized with acrylonitrile and styrene. The acrylic impact modifiers can also include silicone in the core, either in partial form along with an alkyl acrylate, or solely with silicone. In some embodiments, flame and smoke composition with CPVC as the polymer resin can include an acrylic impact modifier having an acrylic homopolymer surface of, for example, methyl methacrylate, or acrylic copolymerized surface, such as methyl methacrylate copolymerized with styrene or acrylonitrile, along with an inner core of an acrylic homopolymer (e.g., butyl acrylate) or an acrylic copolymer, for example, butyl acrylate with ethyl hexyl acrylate. In some embodiments, the inner core of the acrylic impact modifier can also include silicone. The acrylic impact modifier may be present in a CPVC composition at from about 3 to about 10 phr, or from about 4 to 9 phr, or even from about 5 to about 8 phr.

Methyl butadiene styrene (“MBS”) impact modifiers can also be added to the compositions. MBS polymers are graft polymers. Generally, MBS impact modifiers are prepared by polymerizing methyl methacrylate or mixtures of methyl methacrylate with other monomers in the presence of polybutadiene or polybutadiene-styrene rubbers. Further information on MBS impact modifiers can be found in the Second Edition of the Encyclopedia of PVC, edited by Leonard I. Nass, Marcel Dekker, Inc. (N.Y. 1988, pp. 448-452). Examples of commercially available MBS impact modifiers include Paraloid KM™ 680, BTA™ 733, 751, and 753 available from Rohm 86 Haas, Kane Ace™ B-22 impact modifier and Kane Ace™ B-56 impact modifier available from Kaneka.

Typical of the graft copolymer impact modifiers are those generally referred to as “ABS” resins, which may generally be described as copolymers of styrene and acrylonitrile on butadiene containing rubber. ABS modifiers are usually prepared by polymerizing styrene and acrylonitrile in the presence of polybutadiene rubber. Examples of commercially available ABS impact modifiers which can be used in the instant invention include Blendex® 338, Blendex® 310 and Blendex® 311; all available from Galata Chemicals. If used as the impact modifier of choice, approximately 5 parts to about 15 parts of ABS impact modifier are used. Preferably, 6 parts of the ABS impact modifier are used.

While the compositions may also contain other impact modifiers, such as ABS or MBS modifiers, in an embodiment the composition can be essentially free, to completely free of any other such impact modifiers.

In addition to the polymer resin and synergistic flame and smoke additive, other ingredients typically added to plastic compounds can be included in the compositions. The amount and nature of these ingredients is dependent upon the end use of the plastic compound. The ingredients and their amount can be tailored to meet the end-use needs by one of ordinary skill in the art.

Chlorinated polyethylene (CPE) can also be added to the compositions. CPE is a rubbery material resulting from the chlorination of polyethylene having a substantially linear structure. The polyethylene can be chlorinated by various methods including aqueous suspension, solution or gas phase methods. An example of a method for preparing CPE can be found in U.S. Pat. No. 3,563,974. Preferably, the aqueous suspension method is used to form the CPE. If used as an impact modifier, the CPE material contains from 5 to 50% by weight of chlorine. Preferably, the CPE contains from 25 to 45% by weight of chlorine. However, the CPE can comprise a mixture of chlorinated polyethylenes, provided that the overall mixture has a chlorine content in the range of about 25 to 45% by weight chlorine. CPE is commercially available from The DuPont Dow Elastomer Company. The preferred CPE materials to be used in the compound include Tyrin™ 3611P, 2000 and 3615P; all available from the DuPont Dow Elastomer Company. Tyrin is a trademark of the DuPont Dow Elastomer Company.

The compositions can also include a stabilizer system. Organotin stabilizers are currently the most recognized heat stabilizers. These stabilizers include alkyl tin mercaptides, alkyl tin carboxylate and alkyl tin maleate. Stabilizers based on a composition of mono and dialkyl tin (2-ethyl hexyl mercapto acetate systems) are suitable. Optionally, a co-stabilizer can be used in conjunction with the stabilizer. Co-stabilizers, if used in conjunction with the main stabilizer, are used in small amounts, such as from 0.1 to 1.0 part by weight per 100 parts by weight of polymer resin, and preferably from 0.1 to 0.5 parts by weight. Suitable co-stabilizers include salts of carboxylic acids, disodium phosphate, sodium citrate, zeolite and hydrotalcite. The amount of heat stabilizer used is at least 1.0 part by weight and preferably at least 1.5 parts by weight.

The stabilizer can also be an organic based stabilizer. In simplest terms, organic based stabilizers (OB-Stabilizers) are non-metal containing stabilizers based on organic chemistry. While the OB-Stabilizers suitable for the stabilizer system herein are not particularly limited, the most prevalent OB-Stabilizer compounds today include uracil and its derivatives. A common derivative of uracil suitable as an OB-Stabilizer for the composition herein is 6-amino-1,3-dimethyluracil. Other commercially available OB-Stabilizers suitable for the present composition include, for example, the Mark™ OBS™ line of stabilizers available from Galata™.

In general, the OB-Stabilizers can be included in the composition at levels required to meet physical properties, such as color. The OB-Stabilizers can be present in an amount of from about 0.05 or 0.1 to about 2.0 parts by weight per 100 parts by weight of said polymer resin. In some embodiment, the OB-Stabilizers can be present from about 0.15 to about 1.75 phr, or from about 0.2 to about 1.5 phr, or even from about 0.25 or 0.5 to about 1.25 phr.

Zeolite and/or C₆ to C₁₂ metal carboxylates, or combinations thereof may also be employed as stabilizers, or co-stabilizers alongside tin or OBS stabilizers.

As a sole stabilizer, the zeolite can generally be present at from about 0.1 to about 4.0 phr. In some embodiments, the zeolite can be present from about 0.25 to about 3.5 phr, or 0.5 to about 3.0 phr. In another embodiment, the zeolite can be present from about 0.75 to about 1.5 or 2.5 phr.

The C₆ to C₁₂ metal carboxylate can be a metal salt of a saturated C₆, or C₇, or C₈ to C₁₁, or C₁₂ aliphatic carboxylate or di-carboxylate, an unsaturated C₆ to C₁₂ aliphatic carboxylate or di-carboxylate, a saturated C₆ to C₁₂ aliphatic carboxylate or di-carboxylate substituted with at least one OH group, or whose chain is interrupted by at least one oxygen atom (oxyacids), or a cyclic or bicyclic carboxylate or di-carboxylate containing from 6, or 7, or 8 to 11 or 12 carbon atoms. Suitable metals for the metal carboxylate can include Li, K, Mg, Ca, and Na.

Preferably the C₆, or C₇ or C₈ to C₁₁ or C₁₂ metal carboxylate is a sodium carboxylate, most preferably a disodium carboxylate, such as disodium sebacate, disodium dodecanedioate or disodium suberate, and combinations thereof. Other examples of C₆ to C₁₂ metal carboxylates that may be employed include disodium adipate, disodium azelate, and disodium undecanedioate.

The C₆ to C₁₂ metal carboxylate can be present from about 0.1 to about 4.0 phr. In some embodiments, the C₆ to C₁₂ metal carboxylate can be present from about 0.25 to about 3.0 phr, or 0.5 to about 2.5 phr. In a preferred embodiment, the C₆ to C₁₂ metal carboxylate can be present from about 1.0 to about 2.0 phr. The metal carboxylate can be dry blended with other ingredients of a compound or the polymer resin can be coated with a metal carboxylate solution by a wet coating process followed by drying to obtain a metal carboxylate coated polymer resin.

In one embodiment, other co-stabilizers beside zeolite and carboxylate may also be employed in the co-stabilizer system. In an embodiment, the stabilizer system is essentially free of, or free of heavy metal stabilizers, such as tin stabilizers. By essentially free of it is meant that a minor portion may be present in amounts that do not contribute or contribute an insignificant amount to stabilization.

Other additives can also be added to the composition as needed. Conventional additives known in the art as well any other additives may be used, provided that the additive does not alter the physical properties and the process stability associated with the novel compounds. Examples of additives which can be used include antioxidants, lubricants, other stabilizers, other impact modifiers, pigments, glass transition enhancing additives, processing aids, fusion aids, fillers, fibrous reinforcing agents and antistatic agents.

Exemplary lubricants are polyglycerols of di- and trioleates, polyolefins such as polyethylene, polypropylene and oxidized polyolefins such as oxidized polyethylene and high molecular weight paraffin waxes. Since several lubricants can be combined in countless variations, the total amount of lubricant can vary from application to application. Optimization of the particular lubricant composition is not within the scope of the present invention and can be determined easily by one of ordinary skill in the art. Preferably, an oxidized polyethylene is used. An example of an oxidized polyethylene is A-C® 629A, sold by Honeywell. In addition to the oxidized polyethylene, preferably a paraffin wax may also be included in the compounds of the instant invention. An example of a paraffin wax is Rheolub™ R-165 from Honeywell.

Suitable processing aids include acrylic polymers such as methyl acrylate copolymers. Examples of process aids include Paraloid™ K-120ND, K-120N, K-175; all available from Rohm 86 Haas. A description of other types of processing aids which can be used in the compound can be found in The Plastics and Rubber Institute: International Conference on PVC Processing, Apr. 26-28 (1983), Paper No. 17.

An example of antioxidants to be used in the halogen containing compounds include Irganox® 1010 (tetrakis[methylene(3,5-di-tert-butyl-4-hydroxy-hydrocinnamate)]methane) sold by BASF, if used at all.

Suitable pigments include organic pigments and inorganic mixed metal oxides. Pigments can include, among others, titanium dioxide, and carbon black. Examples of titanium dioxide is Tiona RCL-6 and RCL-4 from Millenium Inorganics. An example of carbon black is Raven 410, available from Columbian Chemicals or Black Pearls 880 from Cabot.

Suitable inorganic fillers include talc, clay, mica, wollastonite, silicas, and other filling agents.

In an embodiment, the technology provides a rigid pipe comprising (a) at least one polymer resin, (b) at least one molybdate salt, and (c) magnesium hydroxide. In an embodiment, the technology provides a rigid pipe comprising (a) at a mixture of two different polymer resins, (b) at least one molybdate salt, and (c) magnesium hydroxide. In an embodiment, the technology provides a rigid pipe comprising (a) at least one polymer resin, (b) two different molybdate salts, and (c) magnesium hydroxide. In an embodiment, the technology provides a rigid pipe comprising (a) at a mixture of two different polymer resins, (b) two different molybdate salts, and (c) magnesium hydroxide. In some instances of the embodiments containing two different polymer resins, the resins can consist of PVC and CPVC.

“Rigid” in this specification can be defined according to ASTM D883. More specifically, the term rigid as used herein means a polymer application, such as a rigid pipe or conduit, having a either a flexural or tensile modulus of elasticity of 700 MPa (100,000 psi) or more measured at a temperature of 23° C. in an atmosphere of 50% relative humidity when tested in accordance with Test Methods ASTM D747, D790, D638, or D882.

In an embodiment, the technology provides a flexible pipe comprising (a) at least one polymer resin, (b) at least one molybdate salt, and (c) magnesium hydroxide.

In an embodiment, the technology provides a molded fitting comprising (a) at least one polymer resin, (b) at least one molybdate salt, and (c) magnesium hydroxide.

The term pipe includes the term “tube” as used in ASTM D2846 when specifying dimensions for copper tube size (CTS) tubes and also includes pipes made to dimensions of iron pipe size (IPS). The term “pipe” as used herein includes CTS and IPS pipes and tubes.

In an embodiment, the flame and smoke composition disclosed herein is suitable for rigid or pressure pipe and fitting applications, such as, for example, drain, waste and vent pipes (“DWV”) or other rigid pipes that need to meet the E84 test requirements for plenum applications with a flame spread of less than 25 and a smoke index of less than 50. The combination of additives provides a synergistic formulation to pass the demanding E84 test.

In an embodiment, the flame and smoke composition disclosed herein is suitable for rigid or pressure pipe and fitting applications, such as, for example, ordinary hazard pipe applications, such as fire sprinkler applications, that need to meet the UL 852 test requirements for ordinary hazard applications. The combination of additives provides a synergistic formulation to pass the demanding UL 852 test.

To make a pipe the ingredients (i.e., polymer resin, such as CPVC, PVC, ABS, etc.; molybdate salt, Mg(OH)₂ and other optional additives) are combined and mixed in a mixer, such as a Henschel mixer, or ribbon blender and either cubed or preferably left in powder form. The powder is fed to either a single, or preferably, a twin-screw extruder and extruded with heat to make the pipe.

Pipe made with a composition as disclosed herein, and specifically CPVC pipe, can meet the cell class 2-3-4-4-7 and also can meet cell class 2-4-4-4-8. Such pipes can be any of the SDR sizes. The pipe can have any of the dimensions specified in ASTM F442 for IPS pipes or ASTM D2846 for CTS pipes. The pipe can also have dimensions as specified in ASTM F441 which includes Schedule 40 and Schedule 80 pipes. SDR-11 is the most common size CPVC pipe for transporting water in homes, apartment buildings, and commercial buildings. SDR-13.5 CPVC pipe is used in fire sprinkler applications. Schedule 40 and 80 are frequently used in industrial applications to transport various chemicals. In some instances, the SDR can be 100. In some instance, the SDR can be 120.

Piping systems can be made by using multiple lengths of the pipe, together with couplers having various angles. The lengths of pipe are joined together by couplers, which are called pipe fittings, to create a piping system. A mechanical fitting can be used to join the lengths of pipe. Mechanical fittings are well known in the plumbing field and are readily available from plumbing supply merchants. Mechanical fittings are typically made with a metal body and use rubber seals to make them water tight.

The pipe can also be joined to a fitting by the use of a solvent cement. In an embodiment, the technology provides a solvent cement comprising (a) at least one polymer resin, (b) at least one molybdate salt, and (c) magnesium hydroxide.

Solvent cementing is a process in which thermoplastics, usually amorphous, are softened by the application of a suitable solvent or mixture of solvents, and then pressed together to affect a bond. The resin itself, after evaporation of the solvent, acts as the filler. Many thermoplastic substrates are easier to join effectively by solvent cements than by conventional adhesive bonding. Generally, a small amount of the resin to be cemented is dissolved in a solvent to form the cement. The inclusion of the resin aids in gap filling, accelerates setting, and reduces shrinkage and internal stresses.

Solvent cements also have been utilized to bond different plastic materials to each other, but in such instances, the solvent must be a solvent for both plastics. Usually in such instances, a mixture of solvents is used. The solvent softens (dissolves) the surface of the substrate to be bonded, and the surface becomes tacky. At this point, the surfaces are brought into contact with each other, often under pressure, and dried.

The solvent cement may contain at least about 10% or 20%, or 30% or 50% up to about 60% or 70% or 80% or 85% or 90% by weight of at least one volatile organic liquid which is a solvent for the polymer resin in the cement, as well as the polymer in the composition being cemented. The volatile organic liquid or liquid mixture used as a solvent may be any liquid or liquids which will dissolve the polymer resin, and when the compositions are to be used as adhesives such as solvent cements, the solvent which also is preferably a solvent for the plastic surface or surfaces which are to be welded or bonded together by the adhesive compositions. In addition, the organic liquids which are used as the solvents must be volatile, that is, it must be capable of vaporizing under a wide variety of application temperature conditions. In one embodiment, a volatile solvent is one which is capable of vaporizing at ambient or at temperatures slightly above ambient temperatures. Among the solvents which may be included in the compositions of the invention and which have been commonly used alone or in combination for adhesive compositions are lower alcohols such as methanol, ethanol and isopropanol; ketones such as acetone, methyl ethyl ketone (MEK), methyl propyl ketone (MPK), methyl isobutyl ketone, isophorone and cyclohexanone (CYH); esters such as methyl acetate, ethyl acetate, ethyl formate, ethyl propionate, and butyl acetate; halogenated solvents such as methylene chloride, ethylene dichloride, trichloroethylene; ethers such as methyl Cellosolve and dioxane; and other liquids such as tetrahydrofuran (THF), gamma-butyrolactone, N-methyl pyrollidone (NMP) and dimethylformamide (DMF). As noted earlier, the choice of solvent depends upon the type of polymer resin and the intended use of the composition. For example, if the composition is to be used for cementing two plastic surfaces together, the solvent or at least one solvent in a mixture should be capable of dissolving or softening the surface of the plastic being cemented. Example solvents include tetrahydrofuran, methyl ethyl ketone, acetone, cyclohexanone, N-methyl pyrrolidone (NMP), dimethylformamide (DMF), and mixtures thereof. Mixtures of tetrahydrofuran (THF) and cyclohexanone and a mixture of THF, CYH, MEK and acetone are useful solvents in adhesive compositions when the polymer resin is PVC. When the polymer resin is CPVC, THF or mixtures of THF, CYH, MEK and acetone are useful solvents.

In some embodiments, the solvent cement may also include an acrylic, vinyl aromatic, and/or vinyl pyrrolidone polymer in as little as about 3 wt. %, although minimum additional resin concentrations of at least about 5, 10, 15, 20, 30 or even 40 wt. % are also contemplated. Similarly, additional resin concentrations as high as about 60 wt. % can also be used, although maximum additional resin concentration of no more than about 50, 40, 30 or even 25 wt. % are also contemplated. Additional resin concentrations on the order of 5 to 20 wt. %, or even 7 to 15 wt. %, are typical.

In some embodiments, the solvent cement may additionally include a solid particulate inorganic filler, such as, for example, from 0 to about 4% or even up to 5% by weight, or about 0.1% or 0.75% by weight up to about 1.5% or 3% or 4% by weight of the solid particulate inorganic filler.

The flame and smoke composition is also suitable for profile applications, such as, siding, window framing, cabinet finishes, flooring, aircraft interior, roofing tiles, cap stock and the like. In one embodiment, the technology provides a molded profile or extruded sheet comprising (a) at least one halogenated polymer resin, (b) at least one molybdate salt, and (c) magnesium hydroxide.

The flame and smoke composition is also suitable for semiconductor applications. In one embodiment, the technology provides a semiconductor device comprising at least one substrate comprising (a) at least one halogenated polymer resin, (b) at least one molybdate salt, and (c) magnesium hydroxide. The composition can be employed in the semiconductor, or in materials used to prepare the semiconductor, such as a plastic (e.g., PVC or CPVC) wet bench.

The flame and smoke composition is also suitable for wire and cable applications. Wire and cable applications include, for example, communications applications, power distribution and transmission applications, home appliances, automotive, and other applications. Wire and cable applications include an insulating jacket surrounding, for instance, copper or aluminum wire, fiber optics, and other wires. In one embodiment, the technology provides a wire or cable insulating jacket comprising (a) at least one halogenated polymer resin, (b) at least one molybdate salt, and (c) magnesium hydroxide.

The flame and smoke composition is also suitable for electrical conduit applications. Electrical conduits can be employed to isolate and route wire to avoid exposure of the wires, and reduce the risk of short circuits or electrocution, and minimize fires. Electrical conduits can be used in IT and telecommunications applications, construction, healthcare applications, energy and utility applications, and manufacturing applications, among other applications. Electrical conduit can be rigid or flexible. In one embodiment, the technology provides an electrical conduit comprising (a) at least one halogenated polymer resin, (b) at least one molybdate salt, and (c) magnesium hydroxide. In one embodiment the electrical conduit can be rigid. In one embodiment, the electrical conduit can be flexible.

The use of the flame and smoke composition disclosed herein provides enhanced smoke reduction and enhanced flame reduction in both rigid and flexible plastic applications prepared from the flame and smoke composition compared to other formulations.

This flame and smoke composition may also be suitable as a polymeric concentrate or masterbatch in the compounding industry for the same applications, which could include any of the aforementioned “other additives.” The concentration of flame and smoke additives could vary from −20 wt % to −70 wt % in the carrier with additives of interest. Further, the flame and smoke masterbatch could be utilized in a dry form along with a flow aid or as a prill.

The invention will now be demonstrated with examples, which are not intended to be limiting but show the best mode of the invention.

### EXAMPLES

Sample formulations were tested for flame resistance. Five-foot length pipes were prepared and subjected to a 1600° F. flame for 1 minute. The pipes were then pressurized to 60 psi to with a water flow rate of ˜10-15 gpm for another 4 minutes. If the pipe did not burst, cross sections were taken and the residual pipe wall thickness was measured. The formulations tested are shown in Tables 1-6 below.

TABLE 1

| | 1 | 2 | 3 | 4 | 5 | 6 | 7 | 8 |
|---|---|---|---|---|---|---|---|---|
| General Description | phr | phr | phr | phr | phr | phr | phr | phr |
| CPVC resin, | 100.00 | 100.00 | 100.00 | 100.00 | 100.00 | 100.00 | 100.00 | 100.00 |
| chlorine content | | | | | | | | |
| 67% | | | | | | | | |
| Tin Stabilizer | 2.20 | 2.20 | 2.20 | 2.20 | 2.20 | 2.20 | 2.20 | 2.20 |
| colorant | 4.12 | 0.50 | 0.50 | 0.50 | 0.50 | 0.50 | 0.50 | 0.50 |
| Chlorinated | 2.00 | 2.00 | 2.00 | 2.00 | 2.00 | 2.00 | 2.00 | 2.00 |
| polyethylene | | | | | | | | |
| ABS impact | 4.00 | 6.00 | 6.00 | 6.00 | 6.00 | 6.00 | 6.00 | 6.00 |
| modifier | | | | | | | | |
| Lubricant | 2.00 | 2.00 | 2.00 | 2.00 | 2.00 | 2.00 | 2.00 | 2.00 |
| Zeolite | | 0.50 | 0.50 | 0.50 | 0.50 | 0.50 | 0.50 | 2.00 |
| Calcium molybdate | | | 2.50 | 2.50 | | 5.00 | 5.00 | |
| Magnesium | | 2.50 | | 2.50 | 5.00 | | 5.00 | |
| hydroxide | | | | | | | | |
| Ammonium | | | | | | | | 3.00 |
| octamolybdate | | | | | | | | |
| % Wall Retention, | 12 | 13 | 12 | 23 | 11 | 19 | 35 | 19 |
| Thinnest Area | | | | | | | | |
| Pipe Thickness | 1″ IPS | 1″ IPS | 1″ IPS | 1″ IPS | 1″ IPS | 1″ IPS | 1″ IPS | 1″ IPS |
| | SCH100 | SCH80 | SCH80 | SCH80 | SCH80 | SCH80 | SCH100 | SCH100 |

TABLE 2

| | 1 | 9 | 10 | 11 | 12 | 13 | 14 | 15 |
|---|---|---|---|---|---|---|---|---|
| General Description | phr | phr | phr | phr | phr | phr | phr | phr |
| CPVC resin, | 100.00 | | | 100.00 | 100.00 | 100.00 | 100.00 | 100.00 |
| chlorine content | | | | | | | | |
| 67% | | | | | | | | |
| CPVC resin, | | 100.00 | | | | | | |
| chlorine content | | | | | | | | |
| 68% | | | | | | | | |
| CPVC resin, | | | 100.00 | | | | | |
| chlorine content | | | | | | | | |
| 66% | | | | | | | | |
| Tin Stabilizer | 2.20 | 2.20 | 2.20 | 2.20 | 2.20 | 2.20 | 2.20 | 2.20 |
| colorant | 4.12 | 0.25 | 0.25 | 0.25 | 0.25 | 0.25 | 0.25 | 0.25 |
| Chlorinated | 2.00 | 2.00 | 2.00 | | 2.00 | 2.00 | 2.00 | 2.00 |
| polyethylene | | | | | | | | |
| ABS impact | 4.00 | 4.00 | 4.00 | | 5.00 | 5.00 | 5.00 | 4.00 |
| modifier | | | | | | | | |
| Acrylic impact | | | | 4.00 | | | | |
| modifier | | | | | | | | |
| Lubricant | 2.00 | 2.00 | 2.00 | 1.75 | 2.00 | 2.00 | 2.25 | 2.00 |
| Zeolite | | 0.50 | 0.50 | 0.50 | 0.50 | 0.50 | 0.50 | 0.50 |
| Dipentaerythritol | | | | | | | | 5.00 |
| Calcium molybdate | | | | | 2.50 | 5.00 | 7.50 | 5.00 |
| Magnesium | | | | | 2.50 | 2.50 | 2.50 | 2.50 |
| hydroxide | | | | | | | | |
| Ammonium | | | | | | | | |
| octamolybdate | | | | | | | | |
| % Wall Retention, | 13 | 6 | Burst | Burst | 23 | 24 | 29 | Burst |
| Thinnest Area | | | | | | | | |
| Pipe Thickness | 1″ IPS | 1″ IPS | 1″ IPS | 1″ IPS | 1″ IPS | 1″ IPS | 1″ IPS | 1″ IPS |
| | SCH80 | SCH80 | SCH80 | SCH80 | SCH80 | SCH80 | SCH80 | SCH80 |

TABLE 3

| | 1 | 16 | 17 | 18 | 19 |
|---|---|---|---|---|---|
| General Description | phr | phr | phr | phr | phr |
| CPVC pipe resin, | 100.00 | 100.00 | 100.00 | 100.00 | 100.00 |
| chlorine content 67% | | | | | |
| Tin Stabilizer | 2.20 | 2.20 | 2.20 | 2.20 | 2.20 |
| colorant | 4.12 | 0.25 | 0.25 | 0.25 | 0.25 |
| Chlorinated | 2.00 | 2.00 | 2.00 | 2.00 | 2.00 |
| polyethylene | | | | | |
| ABS impact modifier | 4.00 | 5.00 | 5.00 | 5.00 | 5.00 |
| Lubricant | 2.00 | 2.00 | 2.00 | 2.00 | 2.00 |
| Zeolite | | 0.50 | 0.50 | 0.50 | 0.50 |
| Calcium molybdate | | | 2.50 | | 5.00 |
| D50 = 0.5 | | | | | |
| Calcium molybdate | | 2.50 | | 5.00 | |
| Magnesium | | 2.50 | 2.50 | 2.50 | 2.50 |
| hydroxide | | | | | |
| % Wall Retention, | 9 | 27 | 33 | 22 | 36 |
| Thinnest Area | | | | | |
| Pipe Thickness | 2″ IPS | 2″ IPS | 2″ IPS | 2″ IPS | 2″ IPS |
| | SCH80 | SCH80 | SCH80 | SCH80 | SCH80 |

TABLE 4

| | 1 | 20 | 21 | 22 | 23 | 24 | 25 | 26 | 27 |
|---|---|---|---|---|---|---|---|---|---|
| General Description | phr | phr | phr | phr | phr | phr | phr | phr | phr |
| CPVC resin, | 100.00 | 100.00 | 100.00 | 100.00 | 100.00 | 100.00 | | 100.00 | 100.00 |
| chlorine content | | | | | | | | | |
| 67% | | | | | | | | | |
| CPVC resin, | | | | | | | 100.00 | | |
| chlorine content | | | | | | | | | |
| 68% | | | | | | | | | |
| Tin Stabilizer | 2.20 | 2.20 | 2.20 | 2.20 | 2.20 | 2.20 | 2.20 | 2.2 | 2.20 |
| colorant | 4.12 | 0.25 | 0.25 | 0.25 | 0.25 | 0.25 | 0.25 | 0.25 | 0.25 |
| Chlorinated | 2.00 | 2.00 | 2.00 | 2.00 | 2.00 | 2.00 | 2.00 | 2.00 | 2.00 |
| polyethylene | | | | | | | | | |
| ABS impact | 4.00 | 6.00 | 6.00 | 6.00 | 6.00 | 6.00 | 6.00 | 6.00 | 6.00 |
| modifier | | | | | | | | | |
| Lubricant | 2.00 | 2.00 | 2.00 | 2.00 | 2.00 | 2.00 | 2.00 | 2.00 | 2.00 |
| Decabromodiphenyl | | | | | | | | 7.50 | |
| ether | | | | | | | | | |
| Antimony Oxide | | | | | | | | 2.50 | |
| Calcium molybdate | | 5.00 | | 7.50 | 5.00 | 5.00 | 5.00 | | 6.25 |
| D50=0.5 | | | | | | | | | |
| Calcium molybdate | | | 5.00 | | | | | | |
| Magnesium | | 2.50 | 2.50 | 2.50 | 5.00 | 7.50 | 2.50 | | 2.50 |
| hydroxide | | | | | | | | | |
| % Wall Retention, | 6 | 26 | 24 | 26 | 28 | 38 | 25 | Burst | 31 |
| Thinnest Area | | | | | | | | | |
| Pipe Thickness | 2″ IPS | 2″ IPS | 2″ IPS | 2″ IPS | 2″ IPS | 2″ IPS | 2″ IPS | 2″ IPS | 2″ IPS |
| | SCH80 | SCH80 | SCH80 | SCH80 | SCH80 | SCH80 | SCH80 | SCH80 | SCH80 |

TABLE 5

| | 1 | 28 | 29 | 30 | 31 | 32 | 33 |
|---|---|---|---|---|---|---|---|
| General Description | phr | phr | phr | phr | phr | phr | phr |
| CPVC resin, chlorine | 100.00 | 100.00 | 100.00 | 100.00 | 100.00 | 100.00 | 100.00 |
| content 67% | | | | | | | |
| Tin Stabilizer | 2.20 | 2.20 | 2.20 | 2.20 | 2.20 | 2.20 | 2.20 |
| colorant | 4.12 | 0.25 | 0.25 | 0.25 | 0.25 | 0.25 | 0.25 |
| Chlorinated | 2.00 | 2.00 | 2.00 | 2.00 | 2.00 | 2.00 | 2.00 |
| polyethylene | | | | | | | |
| ABS impact modifier | 4.00 | 6.00 | 6.00 | 6.00 | 6.00 | 7.00 | 7.00 |
| Lubricant | 2.00 | 2.00 | 2.00 | 2.00 | 2.00 | 2.00 | 2.00 |
| Zeolite | | 0.50 | 0.50 | 0.50 | 0.50 | 0.50 | 0.50 |
| Calcium molybdate | | 5.00 | | 2.50 | 5.00 | 5.00 | 5.00 |
| D50=0.5 | | | | | | | |
| Magnesium hydroxide | | | 5.00 | 7.50 | 7.50 | 10.00 | 15.00 |
| % Wall Retention, | Burst | 16 | 8 | 33 | 39 | 38 | 30 |
| Thinnest Area | | | | | | | |
| Pipe Thickness | 2″ IPS | 2″ IPS | 2″ IPS | 2″ IPS | 2″ IPS | 2″ IPS | 2″ IPS |
| | SCH80 | SCH80 | SCH80 | SCH80 | SCH80 | SCH80 | SCH80 |

TABLE 6

| | 1 | 34 | 35 |
|---|---|---|---|
| General Description | phr | phr | phr |
| CPVC resin, | 100.00 | 100.00 | 100.00 |
| chlorine content 67% | | | |
| Tin Stabilizer | 2.20 | 2.20 | 2.50 |
| colorant | 4.12 | 0.25 | 0.25 |
| Chlorinated | 2.00 | 2.00 | 2.00 |
| polyethylene | | | |
| ABS impact modifier | 4.00 | 6.00 | 7.00 |
| Lubricant | 2.00 | 2.00 | 2.25 |
| Zeolite | | 0.50 | 0.50 |
| Calcium molybdate | | 3.50 | |
| D50 = 0.5 | | | |
| Calcium molybdate | | | |
| Magnesium hydroxide | | 7.50 | 10.00 |
| Ammonium | | | 10.00 |
| octamolybdate | | | |
| % Wall Retention, | Burst | 29 | 33 |
| Thinnest Area | | | |
| Pipe Thickness | 2″ IPS | 2″ IPS | 2″ IPS |
| | SCH80 | SCH80 | SCH80 |

Sample was prepared as shown in Tables 7 and 8 and tested according to UL 852.

TABLE 7

| | 1 | 36 | 37 | 38 | 39 |
|---|---|---|---|---|---|
| | Pipe | 1″ Sch. | 1″ Sch. | 1″ Sch. | 1″ Sch. |
| | Control | 80 Pipe | 80 Pipe | 80 Pipe | 80 Pipe |
| General Description | phr | phr | phr | phr | phr |
| CPVC resin, | 100.00 | 100.00 | 100 | 100 | 100 |
| chlorine content 67% | | | | | |
| CPVC resin, | | | | | |
| chlorine content 66% | | | | | |
| Tin Stabilizer | 2.20 | 2.20 | 2.20 | 2.20 | 2.20 |
| colorant | 4.12 | 4.00 | 0.25 | 0.25 | 0.25 |
| Chlorinated | 2.00 | 2.00 | 2.00 | 2.00 | 2.00 |
| polyethylene | | | | | |
| MBS Impact Modifier | | | | | |
| ABS impact modifier | 4.00 | 4.00 | 5.00 | 5.00 | 5.00 |
| Lubricant | 2.00 | 2.00 | 2.00 | 2.00 | 2.25 |
| antioxidant | | | | | |
| Zeolite | | 0.50 | 0.50 | 0.50 | 0.50 |
| Calcium molybdate | | 2.50 | 2.50 | 5.00 | 7.50 |
| Magnesium hydroxide | | 2.50 | 2.50 | 2.50 | 2.50 |
| Stage 1 Fire Exposure | 46 | 284 | Pass | Pass | Pass |
| Time Before Pipe | | | | | |
| Burst(s) (seconds) | | | | | |

TABLE 8

| | 1 | 40 | 41 | 42 | 43 | 44 |
|---|---|---|---|---|---|---|
| | Pipe | 2″ Sch. | 2″ Sch. | 2″ Sch. | 2″ Sch. | 2″ Sch. |
| | Control | 80 Pipe | 80 Pipe | 80 Pipe | 80 Pipe | 80 Pipe |
| General Description | phr | phr | phr | phr | phr | phr |
| CPVC resin, chlorine content 67% | 100.00 | 100.00 | 100 | 100 | 100 | 100 |
| CPVC resin, chlorine content 66% | | | | | | |
| Tin Stabilizer | 2.20 | 2.20 | 2.20 | 2.20 | 2.20 | 2.20 |
| colorant | 4.12 | | | 0.25 | 0.25 | 0.25 |
| Chlorinated polyethylene | 2.00 | 2.25 | 2.25 | 2.00 | 2.00 | 2.00 |
| MBS Impact Modifier | | | | | | |
| ABS impact modifier | 4.00 | 5.00 | 5.00 | 6.00 | 6.00 | 6.00 |
| Lubricant | 2.00 | 2.25 | 2.25 | 2.00 | 2.00 | 2.00 |
| antioxidant | | | | | | |
| Zeolite | | 0.50 | 0.50 | 0.50 | 0.50 | 0.50 |
| Calcium molybdate | | 2.50 | 5.00 | 3.50 | 5.00 | 5.00 |
| Magnesium hydroxide | | 2.50 | 2.50 | 7.50 | 7.50 | 10.00 |
| Stage 1 Fire Exposure Time Before Pipe | 46 | 265 | 268 | Pass | Pass | |
| Burst(s) (seconds) | | | | | | |

Sample formulations were tested in the cone calorimeter test (ASTM E1354) to gauge smoke generation. Briefly, the cone calorimeter test conditions included a 35 kw/m² radiant heat flux with the sample mounted in a vertical position. A plasma spark was used as the ignition source. Each sample formulation was milled into a plaque, compression molded, and cut into 4″×4″×⅛″ samples for the cone calorimeter test. The same sample preparation method was completed for all cone calorimeter samples in these examples.

The CPVC resin employed in the samples was prepared from a 0.92 I.V. PVC resin chlorinated to about 67.25 wt % chlorine content. Each formulation employed an additive package containing 2 phr of a tin stabilizer, 0.5 phr zeolite, 0.2 phr antioxidant, 0.2 phr carbon black, and 2.2 phr lubricant. CPVC formulations are shown in Table 9.

TABLE 9
CPVC Formulations for cone calorimeter tests

| Sample | 45 | 46 | 47 |
|---|---|---|---|
| CPVC resin | 100.0 | 100.0 | 100.0 |
| Additive Package | 4.9 | 4.9 | 4.9 |
| MBS impact modifier | 3.5 | 3.5 | 3.5 |
| Acrylic impact modifier | 5.5 | 5.5 | 5.5 |
| submicron calcium | 5 | 5 | |
| molybdate smoke | | | |
| suppressant | | | |
| Magnesium hydroxide | | 15 | 20 |
| flame retardant | | | |
| total smoke (m²/m²) | 140 | 0 | 100 |
| Peak smoke rate | 0.44 | 0 | 0.42 |
| (m²/m²/S) | | | |
| Peak heat release | 42 | 42 | 32 |
| rate (KW/m²) | | | |

Additional samples were prepared for testing in the large scale “E-84” test (ASTM E84), which measures the surface burning characteristics of building materials.

The sample formulations are set forth in Table 10 below.

TABLE 10
Formulations for pipe and sheets.

| No. | 48 | 49 |
|---|---|---|
| CPVC resin (67.25Cl %) | 100 | 100 |
| tin | 2 | 2 |
| Zeolite | 0.5 | 0.5 |
| Carbon black | 0.2 | 0.2 |
| Acrylic impact | 6 | 6.5 |
| modifier | | |
| Lubricant | 2.2 | 2.2 |
| Antioxidant | 0.2 | 0.2 |
| submicron calcium | 6* | 10** |
| molybdate smoke | | |
| suppressant | | |
| Magnesium hydroxide | 15 | 10 |
| flame retardant | | |

*D50 of 0.5 micron
**D50 of 0.8 micron

Two 0.14 inch thick sheets were prepared from samples 48 and 49 formulations shown in Table 11 below and stacked to form 0.28 inch thick sheets, which were then tested in the E-84 test according to the UL1887 standards. The results for the flame spread index (FSI) and the smoke development index (SDI) are shown in the Table below.

TABLE 11
E-84 results for 0.28″ thick sheets

| No. | 48 | 49 |
|---|---|---|
| FSI | 5 | 5 |
| SDI | 35 | 45 |
| Target on FSI/SDI | <25/50 | <25/50 |

Sample PVC formulations were also tested in the cone calorimeter test (ASTM E1354) to gauge smoke generation. Briefly, the cone calorimeter test conditions for the PVC test were the same as the CPVC test above; which included a 35 kw/m² radiant heat flux with the sample mounted in a vertical position. A plasma spark was used as the ignition source. Each sample formulation was milled into a plaque, compression molded, and cut into 4″×4″×⅛″ samples for the cone calorimeter test. The same sample preparation method was completed for all cone calorimeter samples in these examples. PVC formulations are shown in Table 12 below.

TABLE 12
PVC Formulations for cone calorimeter tests

| Sample | 50 | 51 | 52 |
|---|---|---|---|
| PVC Pipe Grade | 100.0 | 100.0 | 100.0 |
| resin (0.92 IV) | | | |
| Tin stabilizer | 1.5 | 1.5 | 1.5 |
| Submicron zeolite | 0.5 | 0.5 | 0.5 |
| carbon black | 0.2 | 0.2 | 0.2 |
| MBS impact modifier | 3.5 | 3.5 | 3.5 |
| Acrylic impact modifier | 4 | 4 | 4 |
| Lubricants | 2.2 | 2.2 | 2.2 |
| Antioxidant | 0.2 | 0.2 | 0.2 |
| submicron calcium | 5 | 5 | |
| molybdate smoke | | | |
| suppressant | | | |
| Magnesium hydroxide | | 15 | 20 |
| flame retardant | | | |
| total smoke (m²/m²) | 1747 | 1510 | 2545 |
| Peak smoke rate | 7.4 | 4.9 | 6.6 |
| (m²/m²/S) | | | |
| Peak heat release | 133 | 35 | 23 |
| rate (KW/m²) | | | |

Sample TPU and ABS formulations were also tested in the cone calorimeter test (ASTM E1354) to gauge smoke generation. Briefly, the cone calorimeter test conditions for the TPU and ABS test were the same as the CPVC and PVC test above, except that the plaques were mounted in a horizontal position. TPU and ABS formulations are shown in Table 13 below.

TABLE 13
TPU and ABS Formulations for cone calorimeter tests

| | Sample | | | | | |
|---|---|---|---|---|---|---|
| | 53 | 54 | 55 | 56 | 57 | 58 |
| Ether based TPU | 100.0 | 100.0 | 100.0 | | | |
| Extrusion Grade ABS | | | | 100.0 | 100.0 | 100.0 |
| submicron calcium molybdate | 5 | 5 | | 5 | 5 | |
| smoke suppressant | | | | | | |
| Magnesium hydroxide flame | | 15 | 20 | | 15 | 20 |
| retardant | | | | | | |
| total smoke (m²/m²) | 743 | 782 | 1031 | 4102 | 3608 | 3698 |
| Peak smoke rate (m²/ m²/ S) | 8 | 6.6 | 7.5 | 23.8 | 16 | 16.9 |
| Peak heat release rate | 450 | 435 | 413 | 646 | 413 | 462 |
| (KW/ m²) | | | | | | |

In the foregoing description, certain terms have been used for brevity, clarity and understanding, however, no unnecessary limitations are to be implied therefrom, because such terms are used for descriptive purposes and are intended to be broadly construed. Moreover, the descriptions and examples herein are by way of examples and the exemplary embodiment is not limited to the exact details shown and described. The description of the exemplary embodiment included in the Abstract included herewith shall not be deemed to limit the invention to features described therein.

A composition comprising (a) at least one halogenated polymer resin, (b) at least one molybdate salt, and (c) magnesium hydroxide.

The composition of any previous sentence wherein the molybdate salt comprises, consists of, or consists essentially of alkali metal molybdates.

The composition of any previous sentence wherein the molybdate salt comprises, consists of, or consists essentially of alkaline earth metal molybdates.

The composition of any previous sentence wherein the molybdate salt comprises, consists of, or consists essentially of calcium molybdate.

The composition of any previous sentence wherein the molybdate salt comprises, consists of, or consists essentially of magnesium molybdate.

The composition of any previous sentence wherein the molybdate salt comprises, consists of, or consists essentially of ammonium molybdate.

The composition of any previous sentence wherein the molybdate salt comprises, consists of, or consists essentially of ammonium octamolybdate.

The composition of any previous sentence wherein the molybdate salt comprises, consists of, or consists essentially of CaMoO₄.

The composition of any previous sentence wherein the molybdate salt comprises, consists of, or consists essentially of ammonium 5-molybdocobaltate (III).

The composition of any previous sentence wherein the molybdate salt comprises, consists of, or consists essentially of ammonium dimolybdate.

The composition of any previous sentence wherein the molybdate salt comprises, consists of, or consists essentially of ammonium molybdate.

The composition of any previous sentence wherein the molybdate salt comprises, consists of, or consists essentially of ammonium heptamolybdate.

The composition of any previous sentence wherein the molybdate salt comprises, consists of, or consists essentially of ammonium octamolybdate.

The composition of the previous sentence, wherein the molybdate salt has a D50 volume distribution particle size of 1 μm or lower as measured by laser diffraction.

The composition of the previous sentence, wherein the molybdate salt has a D50 volume distribution particle size of 0.75 μm or lower measured by laser diffraction.

The composition of the previous sentence, wherein the molybdate salt has a D50 volume distribution particle size of 0.5 μm or lower measured by laser diffraction.

The composition of any previous sentence wherein the molybdate salt is present at from 0.5 to 20 phr.

The composition of any previous sentence wherein the molybdate salt is present at from 0.75 to 15.

The composition of any previous sentence wherein the molybdate salt is present at from 0.75 to 12.5 phr.

The composition of any previous sentence wherein the molybdate salt is present at from about 1 to 10 phr.

The composition of any previous sentence wherein the molybdate salt is present at from 1.25 to 8 phr.

The composition of any previous sentence wherein the molybdate salt is present at from 1.5 to 8 phr.

The composition of any previous sentence wherein the molybdate salt is present at from 2 to 6 phr.

The composition of any previous sentence wherein the magnesium hydroxide is present at greater than 0.5 phr.

The composition of any previous sentence wherein the magnesium hydroxide is present at from 0.5 to 30 phr.

The composition of any previous sentence wherein the magnesium hydroxide is present at from 0.5 to 25 phr.

The composition of any previous sentence wherein the magnesium hydroxide is present at from 0.75 to 20 phr.

The composition of any previous sentence wherein the magnesium hydroxide is present at from 0.75 to 17.5 phr.

The composition of any previous sentence wherein the magnesium hydroxide is present at from 1 to 15 phr.

The composition of any previous sentence wherein the magnesium hydroxide is present at from 1.25 to 12.5 phr.

The composition of any previous sentence wherein the magnesium hydroxide is present at from 1.5 to 10 phr.

The composition of any previous sentence wherein the magnesium hydroxide is present at from 2 to 10 phr.

The composition of any previous sentence wherein the magnesium hydroxide is present at from 5 to 15 phr.

The composition of any previous sentence wherein the magnesium hydroxide is present at from 9 to 12 phr.

The composition of any previous sentence wherein the molybdate salt and magnesium hydroxide are present in the composition at a ratio of from 5:1 to 1:5.

The composition of any previous sentence wherein the molybdate salt and magnesium hydroxide are present in the composition at a ratio of from 3:1 to 1:3.

The composition of any previous sentence wherein the molybdate salt and magnesium hydroxide are present in the composition at a ratio of from 1:3 or greater (i.e., greater amount of magnesium hydroxide than molybdate salt).

The composition of any previous sentence wherein the molybdate salt and magnesium hydroxide are present in the composition at a ratio of from 1:2 or greater.

The composition of any previous sentence wherein the molybdate salt and magnesium hydroxide are present in the composition at a ratio of from 3:4 or greater.

The composition of any previous sentence wherein the molybdate salt and magnesium hydroxide are present in the composition at a ratio of from 1:1 to about 1:5.

The composition of any previous sentence wherein the molybdate salt and magnesium hydroxide are present in the composition at a ratio of from 1:1 to 1:3.

The composition of any previous sentence wherein the molybdate salt and magnesium hydroxide are present in the composition at a ratio of from 3:4 to 1:2.

The composition of any previous sentence, further comprising (d) an impact modifier.

The composition of any previous sentence, wherein the impact modifier is an acrylic impact modifier.

The composition of any previous sentence, wherein the impact modifier is an MBS impact modifier.

The composition of any previous sentence, wherein the impact modifier is an CPE impact modifier.

The composition of any previous sentence, wherein the impact modifier is an ABS impact modifier.

The composition of any previous sentence, wherein the polymer resin comprises, consists essentially of, or consists of polymers of vinyl chloride.

The composition of any previous sentence, wherein the polymer resin comprises, consists essentially of, or consists of chlorinated polyvinyl chloride (“CPVC”).

The composition of any previous sentence, wherein the polymer resin comprises, consists essentially of, or consists of polyvinyl chloride (“PVC”).

The composition of any previous sentence, wherein the polymer resin comprises, consists essentially of, or consists of copolymers of vinyl chloride with ethylene-type unsaturated compounds.

The composition of any previous sentence, wherein the polymer resin comprises, consists essentially of, or consists of copolymers of PVC-VA (vinyl acetate).

The composition of any previous sentence, wherein the polymer resin comprises, consists essentially of, or consists of copolymers of PVC-acrylate.

The composition of any previous sentence, wherein the polymer resin comprises, consists essentially of, or consists of copolymers of chlorinated polyvinyl chloride (“CPVC”) and about 5 parts or less of a co-monomer.

The composition of any previous sentence, wherein the polymer resin comprises, consists essentially of, or consists of copolymers of chlorinated polyvinyl chloride (“CPVC”) and about 5 parts or less of a co-monomer of esters of acrylic acid wherein the ester portion has from 1 to 12 carbon atoms.

The composition of any previous sentence, wherein the polymer resin comprises, consists essentially of, or consists of copolymers of chlorinated polyvinyl chloride (“CPVC”) and about 5 parts or less of a co-monomer of methyl acrylate.

The composition of any previous sentence, wherein the polymer resin comprises, consists essentially of, or consists of copolymers of chlorinated polyvinyl chloride (“CPVC”) and about 5 parts or less of a co-monomer of ethyl acrylate.

The composition of any previous sentence, wherein the polymer resin comprises, consists essentially of, or consists of copolymers of chlorinated polyvinyl chloride (“CPVC”) and about 5 parts or less of a co-monomer of butyl acrylate.

The composition of any previous sentence, wherein the polymer resin comprises, consists essentially of, or consists of copolymers of chlorinated polyvinyl chloride (“CPVC”) and about 5 parts or less of a co-monomer of octyl acrylate.

The composition of any previous sentence, wherein the polymer resin comprises, consists essentially of, or consists of copolymers of chlorinated polyvinyl chloride (“CPVC”) and about 5 parts or less of a co-monomer of cyano-ethyl acrylate.

The composition of any previous sentence, wherein the polymer resin comprises, consists essentially of, or consists of copolymers of chlorinated polyvinyl chloride (“CPVC”) and about 5 parts or less of a co-monomer of vinyl acetate.

The composition of any previous sentence, wherein the polymer resin comprises, consists essentially of, or consists of copolymers of chlorinated polyvinyl chloride (“CPVC”) and about 5 parts or less of a co-monomer of esters of methacrylic acid wherein the ester portion has from 1 to 12 carbon atoms.

The composition of any previous sentence, wherein the polymer resin comprises, consists essentially of, or consists of copolymers of chlorinated polyvinyl chloride (“CPVC”) and about 5 parts or less of a co-monomer of methyl methacrylate (MMA).

The composition of any previous sentence, wherein the polymer resin comprises, consists essentially of, or consists of copolymers of chlorinated polyvinyl chloride (“CPVC”) and about 5 parts or less of a co-monomer of ethyl methacrylate.

The composition of any previous sentence, wherein the polymer resin comprises, consists essentially of, or consists of copolymers of chlorinated polyvinyl chloride (“CPVC”) and about 5 parts or less of a co-monomer of butyl methacrylate.

The composition of any previous sentence, wherein the polymer resin comprises, consists essentially of, or consists of copolymers of chlorinated polyvinyl chloride (“CPVC”) and about 5 parts or less of a co-monomer of acrylonitrile.

The composition of any previous sentence, wherein the polymer resin comprises, consists essentially of, or consists of copolymers of chlorinated polyvinyl chloride (“CPVC”) and about 5 parts or less of a co-monomer of methacrylonitrile.

The composition of any previous sentence, wherein the polymer resin comprises, consists essentially of, or consists of copolymers of chlorinated polyvinyl chloride (“CPVC”) and about 5 parts or less of a co-monomer of styrene derivatives having a total of from 8 to 15 carbon atoms.

The composition of any previous sentence, wherein the polymer resin comprises, consists essentially of, or consists of copolymers of chlorinated polyvinyl chloride (“CPVC”) and about 5 parts or less of a co-monomer of alpha-methylstyrene.

The composition of any previous sentence, wherein the polymer resin comprises, consists essentially of, or consists of copolymers of chlorinated polyvinyl chloride (“CPVC”) and about 5 parts or less of a co-monomer of vinyl toluene.

The composition of any previous sentence, wherein the polymer resin comprises, consists essentially of, or consists of copolymers of chlorinated polyvinyl chloride (“CPVC”) and about 5 parts or less of a co-monomer of chlorostyrene.

The composition of any previous sentence, wherein the polymer resin comprises, consists essentially of, or consists of copolymers of chlorinated polyvinyl chloride (“CPVC”) and about 5 parts or less of a co-monomer of vinyl naphthalene.

The composition of any previous sentence, wherein the polymer resin comprises, consists essentially of, or consists of copolymers of chlorinated polyvinyl chloride (“CPVC”) and about 5 parts or less of a co-monomer of diolefins having a total of from 4 to 8 carbon atoms.

The composition of any previous sentence, wherein the polymer resin comprises, consists essentially of, or consists of copolymers of chlorinated polyvinyl chloride (“CPVC”) and about 5 parts or less of a co-monomer of isoprene.

The composition of any previous sentence, wherein the polymer resin comprises, consists essentially of, or consists of copolymers of chlorinated polyvinyl chloride (“CPVC”) and about 5 parts or less of a co-monomer of halogenated olefins.

The composition of any previous sentence, wherein the polymer resin comprises, consists essentially of, or consists of copolymers of chlorinated polyvinyl chloride (“CPVC”) and about 5 parts or less of a co-monomer of chlorobutadiene.

The composition of any previous sentence, wherein the polymer resin comprises, consists essentially of, or consists of copolymers of chlorinated polyvinyl chloride (“CPVC”) and about 5 parts or less of a co-monomer of monoolefins having 2 to 10 carbon atoms.

The composition of any previous sentence, wherein the polymer resin comprises, consists essentially of, or consists of copolymers of chlorinated polyvinyl chloride (“CPVC”) and about 5 parts or less of a co-monomer of ethylene.

The composition of any previous sentence, wherein the polymer resin comprises, consists essentially of, or consists of copolymers of chlorinated polyvinyl chloride (“CPVC”) and about 5 parts or less of a co-monomer of propylene.

The composition of any previous sentence, wherein the polymer resin comprises, consists essentially of, or consists of copolymers of chlorinated polyvinyl chloride (“CPVC”) and about 5 parts or less of a co-monomer of isobutylene.

The composition of any previous sentence, wherein the polymer resin comprises, consists essentially of, or consists of copolymers of chlorinated polyvinyl chloride (“CPVC”) and about 5 parts or less of a co-monomer of co-polymerizable imides.

The composition of any previous sentence, wherein the polymer resin comprises, consists essentially of, or consists of copolymers of chlorinated polyvinyl chloride (“CPVC”) and about 5 parts or less of a co-monomer of N-cyclohexyl maleimide.

The composition of any previous sentence, wherein the polymer resin comprises, consists essentially of, or consists of chlorinated polyvinyl chloride (“CPVC”) made from a PVC resin having an intrinsic viscosity (I.V.), measured as stated in ASTM D1243 of from 0.5 to 1.25.

The composition of any previous sentence, wherein the polymer resin comprises, consists essentially of, or consists of chlorinated polyvinyl chloride (“CPVC”) made from a PVC resin having an intrinsic viscosity (I.V.), measured as stated in ASTM D1243 of from 0.68 to 0.92.

The composition of any previous sentence, wherein the polymer resin comprises, consists essentially of, or consists of chlorinated polyvinyl chloride (“CPVC”) made from a PVC resin having an intrinsic viscosity (I.V.), measured as stated in ASTM D1243 of from 0.80 to 1.05.

The composition of any previous sentence, wherein the polymer resin comprises, consists essentially of, or consists of chlorinated polyvinyl chloride (“CPVC”) made from a PVC resin having an intrinsic viscosity (I.V.), measured as stated in ASTM D1243 of from 0.86 to 0.96.

The composition of any previous sentence, wherein the polymer resin comprises, consists essentially of, or consists of chlorinated polyvinyl chloride (“CPVC”) made from a PVC resin having an intrinsic viscosity (I.V.), measured as stated in ASTM D1243 of from 0.68 to 0.92.

The composition of any previous sentence, wherein the polymer resin comprises, consists essentially of, or consists of chlorinated polyvinyl chloride (“CPVC”) having a chlorine content of from about 63 to about 70 wt. %.

The composition of any previous sentence, wherein the polymer resin comprises, consists essentially of, or consists of chlorinated polyvinyl chloride (“CPVC”) having a chlorine content of from about 64 to 69 wt. %.

The composition of any previous sentence, wherein the polymer resin comprises, consists essentially of, or consists of chlorinated polyvinyl chloride (“CPVC”) having a chlorine content of from about 65 to about 68 wt. %.

The composition of any previous sentence, wherein the polymer resin comprises, consists essentially of, or consists of polyvinyl chloride (“PVC”).

A pipe comprising the composition according to any previous sentence and other conventional pipe ingredients.

A molded profile or extruded sheet comprising the composition according to any previous sentence.

A semiconductor device comprising at least one substrate comprising the composition according to any previous sentence.

A wire or cable insulating jacket comprising the composition according to any previous sentence.

An electrical conduit comprising the composition according to any previous sentence.

A pipe fitting comprising the composition according to any previous sentence other conventional pipe ingredients.

A solvent cement comprising the composition according to any previous sentence and other conventional solvent ingredients.

A method of improving surface burning in a polymer resin piping application comprising preparing the piping, fittings, and solvent cement from a composition according to any previous sentence.

A method of improving smoke spread in a polymer resin piping application comprising preparing the piping, fittings, and solvent cement from a composition according to any previous sentence.

Having described the features, discoveries and principles of the invention, the manner in which it is formulated and operated, and the advantages and useful results attained, the new and useful compositions, combinations of ingredients and relationships are set forth in the appended claims.

1. A composition comprising (a) chlorinated polyvinyl chloride (“CPVC”), (b) 0.5 to 20 phr of at least one molybdate salt, and (c) 0.75 to 20 phr of magnesium hydroxide.

2. The composition of claim 1, wherein the molybdate salt has a D50 volume distribution particle size of 1 μm or lower as measured by laser diffraction.

3. (canceled)

4. (canceled)

5. The composition of claim 1, further comprising (d) an impact modifier.

6. The composition of claim 1, wherein the impact modifier is an acrylic impact modifier.

7. The composition of claim 1, wherein the impact modifier is an MBS, CPE or ABS impact modifier.

8. (canceled)

9. The composition of claim 1, wherein the polymer resin comprises, consists essentially of, or consists of polyvinyl chloride (“PVC”).

10. The composition of claim 1, wherein the molybdate salt and magnesium hydroxide are present in the composition at a ratio of from 5:1 to 1:5.

11. A pipe comprising the composition according to claim 1 and other conventional pipe ingredients.

12. A molded profile or extruded sheet comprising the composition according to claim 1.

13. A semiconductor device comprising at least one substrate comprising the composition according to claim 1.

14. A wire or cable insulating jacket comprising the composition according to claim 1.

15. An electrical conduit comprising the composition according to claim 1.

16. A pipe fitting comprising the composition according to claim 1 and other conventional pipe ingredients.

17. A solvent cement comprising the composition according to claim 1 and other conventional solvent ingredients.

18. A method of improving surface burning in a polymer resin piping application comprising preparing the piping, fittings, and solvent cement from a composition according to claim 1.

19. A method of improving smoke spread in a polymer resin piping application comprising preparing the piping, fittings, and solvent cement from a composition according to claim 1.
